(19) United States
(12) Patent Application Publication
(10) Pub. No.: US 2024/0343954 A1
(43) Pub. Date: Oct. 17, 2024

(54) LIQUID EJECTION HEAD AND METHOD OF MANUFACTURING LIQUID EJECTION HEAD

(71) Applicant: CANON KABUSHIKI KAISHA, Tokyo (JP)

(72) Inventors: HARUKA YAMAJI, Tokyo (JP); ISAO IMAMURA, Kanagawa (JP); HIROKI KIHARA, Kanagawa (JP); SATOSHI TSUTSUI, Kanagawa (JP)

(21) Appl. No.: 18/632,924

(22) Filed: Apr. 11, 2024

(30) Foreign Application Priority Data
Apr. 13, 2023 (JP) 2023-065827

(51) Int. Cl. C09J 163/00; B41J 2/14; B41J 2/16; B41J 2/175; C09J 5/00

(52) U.S. Cl. CPC C09J 163/00; B41J 2/14; B41J 2/16; B41J 2/1623; B41J 2/175; C09J 5/00; B41J 2002/14362; C09J 2463/00

(57) ABSTRACT

A liquid ejection head includes a recording element substrate configured to eject a liquid, a supporting member configured to support the recording element substrate and including a supply channel configured to supply a liquid to the recording element substrate, and a channel member configured to supply a liquid to the supply channel, wherein at least one bonding surface between two of the recording element substrate, the supporting member, and the channel member is made of an epoxy resin composition containing an epoxy resin mixture and a powder curing agent, the epoxy resin mixture contains an epoxy resin that is liquid at normal temperature and a coumarone resin that is dissolvable in the epoxy resin, a weight average molecular weight of the epoxy resin mixture is 300 or more and 600 or less, and the liquid ejection head contains a cured substance of an adhesive agent containing the epoxy resin composition.

### BACKGROUND

### Field of the Disclosure

The present disclosure relates to a liquid ejection head for ejecting a liquid such as ink from an ejection port and a method of manufacturing the liquid ejection head.

### Description of the Related Art

In manufacturing of a liquid ejection head represented by an inkjet recording head, an energy generating element and a wiring conductor for supplying power to the energy generating element are arranged on a silicon substrate. After a protective film is arranged on the wiring conductor, a liquid channel and a liquid ejection port are patterned using a resist. A through-hole (liquid supply port) for supplying a liquid from a back surface side of the silicon substrate to an energy generating element portion is formed in the silicon substrate. This recording element substrate is attached to a supporting member made of alumina, resin, or the like with an adhesive agent, and the recording element substrate and an electric wiring member are electrically bonded to each other.

In manufacturing of the liquid ejection head, an adhesive agent and a sealing material that are used for adhesion and sealing of the other members are collectively subjected to main curing in a final process in terms of manufacturing costs. That is, in a process of attaching a supporting plate and the recording element substrate to each other, the adhesive agent has yet been cured. Hence, there is a possibility that the recording element substrate that has been positioned at the time of the attachment is deviated from an attachment position due to movement or the like in a subsequent process. For the above-mentioned reasons, to prevent a positional deviation of the recording element substrate, it is desirable that temporary fixing/curing (temporary fixing) with the adhesive agent be performed within an apparatus to which the recording element substrate is attached.

The adhesive agent for attaching the recording element substrate and the supporting member to each other is required to have high adhesiveness and ink resistance, and is preferably easy to use in a manufacturing process.

For these reasons, there are many cases where a one-component thermosetting epoxy resin composition is used as the adhesive agent for attaching the recording element substrate and the supporting member to each other. As the one-component thermosetting epoxy resin composition, for example, Japanese Patent Application Laid-Open No. 2015-21011 discusses an adhesive agent containing an epoxy resin composition.

Meanwhile, Japanese Patent Application Laid-Open No. 2019-172911 and Japanese Patent Application Laid-Open No. 2021-138809 each discuss an adhesive agent containing an epoxy resin composition containing a coumarone resin.

A one-component thermosetting epoxy resin composition is cured by the progress of a reaction of an epoxy resin and a curing agent by heat. Because the one-component thermosetting epoxy resin composition is a solventless composition, an epoxy resin that is liquid at normal temperature is used. In contrast, the curing agent is preferably in a powder form (solid) in terms of storage stability.

However, in a case of the adhesive agent made of the epoxy resin that is liquid at normal temperature and the powder curing agent, there is an issue of a bleeding phenomenon. This is a phenomenon in which the adhesive agent applied onto the supporting member is crushed to be thin by the recording element substrate and thereafter cured, whereby the epoxy resin bleeds out, and an uncured component remains. Because there is a possibility that contact of the remaining uncured component with a liquid such as ink causes adhesion of the remaining uncured component to a liquid ejection surface and a decrease in accuracy of liquid ejection, it has been demanded to inhibit bleeding in the adhesive agent used in a flow channel of the liquid ejection head.

The bleeding is, as described above, a phenomenon in which only the liquid epoxy resin bleeds out when a thermal curing reaction of the epoxy resin composition progresses. The thermal curing reaction progresses as the powder curing agent softens and liquefies, but the fluidity of the liquid epoxy resin is increased by heat at the same time.

Hence, the fluidity of the epoxy resin needs to be controlled to inhibit the bleeding.

The one-component thermosetting epoxy resin composition discussed in Japanese Patent Application Laid-Open No. 2015-21011 is directed to the above-mentioned inhibition of the bleeding.

However, according to the examination of the inventors of the present disclosure, it has been confirmed that the adhesive agent discussed in Japanese Patent Application Laid-Open No. 2015-21011 has an issue of ink resistance when used in a liquid ejection head.

Furthermore, according to the examination of the inventors of the present disclosure, it has been confirmed that the adhesive agent discussed in Japanese Patent Application Laid-Open No. 2019-172911 and Japanese Patent Application Laid-Open No. 2021-138809 has an issue of compatibility between the ink resistance and the inhibition of bleeding.

### SUMMARY

The present disclosure is directed to provision of a liquid ejection head including an adhesive agent that establishes compatibility between ink resistance and inhibition of bleeding and provision of a method for manufacturing the liquid ejection head.

According to another aspect of the present disclosure, a liquid ejection head includes a recording element substrate configured to eject a liquid, a supporting member configured to support the recording element substrate and including a supply channel configured to supply a liquid to the recording element substrate, and a channel member configured to supply a liquid to the supply channel, wherein at least one bonding surface between two members of any of the recording element substrate, the supporting member, and the channel member is made of an epoxy resin composition containing an epoxy resin mixture and a powder curing agent, wherein the epoxy resin mixture contains an epoxy resin that is liquid at normal temperature and a coumarone resin that is dissolvable in the epoxy resin, wherein a weight average molecular weight of the epoxy resin mixture is 300 or more and 600 or less, and wherein the liquid ejection head contains a cured substance of an adhesive agent containing the epoxy resin composition.

According to yet another aspect of the present disclosure, a method of manufacturing a liquid ejection head, the liquid ejection head including a recording element substrate configured to eject a liquid, a supporting member configured to support the recording element substrate and including a supply channel configured to supply a liquid to the recording element substrate, and a channel member configured to supply a liquid to the supply channel, the liquid ejection head using an adhesive agent containing an epoxy resin composition, the method includes applying the adhesive agent to at least one bonding surface between two members of any of the recording element substrate, the supporting member, and the channel member, bonding the two members to each other, and performing main curing to cure the adhesive agent with heat and bond the two members to each other, wherein the adhesive agent is the epoxy resin composition containing an epoxy resin mixture and a powder curing agent, wherein the epoxy resin mixture contains an epoxy resin that is liquid at normal temperature and a coumarone resin that is dissolvable in the epoxy resin, and wherein a weight average molecular weight of the epoxy resin mixture is 300 or more and 600 or less.

Further features of the present disclosure will become apparent from the following description of exemplary embodiments with reference to the attached drawings.

### BRIEF DESCRIPTION OF THE DRAWINGS

FIG. 1 is a schematic perspective view for describing one exemplary embodiment of a liquid ejection head according to the present disclosure.

FIG. 2 is a schematic cross-sectional view of the liquid ejection head according to the present disclosure.

### DESCRIPTION OF THE EMBODIMENTS

As a result of earnest examination, the inventors of the present disclosure have succeeded in production of an adhesive agent that establishes compatibility between ink resistance and inhibition of bleeding by using a coumarone-indene resin that can dissolve in an epoxy resin (hereinafter referred to as a coumarone resin). The coumarone resin mentioned herein is a copolymer resin mainly composed of coumarone, indene, and styrene. Dissolving the coumarone resin in the epoxy resin can increase a weight average molecular weight of an epoxy resin mixture and decrease fluidity under high temperature. Furthermore, because the coumarone resin has such a skeleton as that the coumarone resin does not swell due to ink, and can also exhibit ink resistance.

A liquid ejection head according to the present disclosure is a liquid ejection head in which an epoxy resin composition is used as an adhesive agent. The epoxy resin composition is an epoxy resin composition containing an epoxy resin mixture and a powder curing agent. The epoxy resin mixture is characterized in that it contains an epoxy resin that is liquid at normal temperature and a coumarone resin that can dissolve in the epoxy resin, and in that a weight average molecular weight of the epoxy resin mixture is 300 or more and 600 or less. A preferable exemplary embodiment of the liquid ejection head according to the present disclosure will be described below. The epoxy resin composition used as the adhesive agent is now to be described.

### <Adhesive Agent>

The adhesive agent used in the liquid ejection head according to the present disclosure is to be described.

The adhesive agent used in the liquid ejection head according to the present disclosure is the epoxy resin composition containing the epoxy resin mixture and the powder curing agent. The epoxy resin mixture contains the epoxy resin that is liquid at normal temperature and the coumarone resin that can dissolve in the epoxy resin. The power curing agent is liquefied by heat, and the liquefied curing agent and the epoxy resin react with each other to form a gel and eventually become the curing agent, whereby the adhesive agent according to the present disclosure is obtained.

As the epoxy resin that is liquid at normal temperature, an alicyclic epoxy resin, an aromatic epoxy resin, an aliphatic epoxy resin, or the like can be used.

Examples of the alicyclic epoxy resin include the following.

The examples include polyhydric alcohol polyglycidyl ether having at least one cyclic aliphatic group (alicyclic group), a cyclohexene oxide structure-containing compound or a cyclopentene oxide structure-containing compound obtained by epoxidizing a cyclohexene/cyclopentene ring-containing compound with an oxidizing agent, and a vinylcyclohexane oxide structure-containing compound obtained by epoxidizing a compound having a vinylcyclohexane structure with an oxidizing agent.

Examples of the alicyclic epoxy resin include the following.

The examples include hydrogenated bis-phenol A diglycidyl ether, 3,4-epoxycyclohexylmethyl-3,4-epoxycyclohexyl carboxylate, 3,4-epoxy-1-methylcyclohexyl-3,4-epoxy-1-methylcyclohexane carboxylate, 6-methyl-3,4-epoxycyclohexylmethyl-6-methyl-3,4-epoxycyclohexane carboxylate, 3,4-epoxy-3-methylcyclohexylmethyl-3,4-epoxy-3-methylcyclohexane carboxylate, 3-4-epoxy-5-methylcyclohexylmethyl-3,4-epoxy-5-methylcyclohexane carboxylate, 2-(3,4-epoxycyclohexyl-5,5-spiro-3,4-epoxy) cyclohexane-metadioxane, bis(3,4-epoxycyclohexylmethyl) adipate, vinylcyclohexenedioxide, 4-vinylepoxycyclohexane, bis(3,4-epoxy-6-methylcyclohexylmethyl) adipate, 3,4-epoxy-6-methylcyclohexyl carboxylate, methylenebis(3,4-epoxycyclohexane), dicyclopentadienediepoxide, ethylene glycoldi(3,4-epoxycyclohexylmethyl)ether, ethylenebis(3,4-epoxycyclohexane carboxylate, epoxyhexahydrophthalic acid dioctyl, and epoxyhexahydrophthalic acid di-2-ethylhexyl.

Specific examples of the aromatic epoxy resin include the following.

The specific examples include polyhydric phenol having at least one aromatic ring, polyglycidyl ether of an alkylene oxide adduct of polyhydric phenol having at least one aromatic ring, and a compound having a naphthalene ring, for example, bisphenol A, bisphenol F, glycidyl ether as a compound obtained by further adding alkylene oxide to bisphenol A or bisphenol F, an epoxy novolac resin, bisphenol A novolac diglycidylether, and bisphenol F novolac diglycidylether.

Examples of the aliphatic epoxy resin include the following.

The examples include aliphatic polyhydric alcohol, polyglycidyl ether of an alkylene oxide adduct of aliphatic polyhydric alcohol, polyglycidyl ester of aliphatic long-chain polybasic acid, an epoxy-containing compound obtained by oxidizing aliphatic long-chain unsaturated hydrocarbon with an oxidizing agent, a homopolymer of glycidyl acrylate or glycidyl methacrylate, and a copolymer of glycidyl acrylate or glycidyl methacrylate.

Representative examples of the aliphatic epoxy resin include the following compounds. The representative examples include polyhydric alcohol glycidyl ether such as 1,4-butanediol diglycidyl ether, 1,6-hexanediol diglycidyl ether, glycerin triglycidyl ether, trimethylolpropane triglycidyl ether, sorbitol tetraglycidyl ether, dipentaerthritol hexaglycidyl ether, polyethylene glycol diglycidyl ether, and polypropylene glycol diglycidyl ether, polyether polyol polyglycidyl ether obtained by adding one kind or two kinds or more of alkylene oxide to aliphatic polyhydric alcohol such as propylene glycol and glycerin, and diglycidyl ester of aliphatic long-chain dibasic acid.

The representative examples further include monoglycidyl ether of aliphatic higher alcohol, phenol, cresol, butylphenol, monoglycidyl ether of polyether alcohol obtained by adding alkylene oxide to each of monoglycidyl ether of aliphatic higher alcohol, phenol, cresol, and butylphenol, glycidyl ester of higher fatty acid, epoxidized soybean oil, octyl epoxystearate, butyl epoxystearate, and epoxidized linseed oil.

Examples of the coumarone resin that can dissolve in the epoxy resin include coumarone resins with product names of Nitto Resin (registered trademark) Coumarone R-100, Nitto Resin Coumarone V-120, and Nitto Resin Coumarone H-100 (each manufactured by Nitto Chemical Co., Ltd.). When the coumarone resin is dissolved in the epoxy resin, heat may be applied to the coumarone resin.

A weight average molecular weight of the epoxy resin mixture in which the coumarone resin is dissolved in the epoxy resin needs to be 300 or more and 600 or less. This is because, in a case where the weight average molecular weight is less than 300, it becomes difficult to inhibit bleeding. This is also because, in a case where the weight average molecular weight is more than 600, it becomes difficult to uniformly disperse molecules when the epoxy resin mixture is mixed with the powder curing agent, and there is a possibility that the ink resistance degrades. The weight average molecular weight is calculated in terms of polystyrene by using gel permeation chromatography (for example, manufactured by Shimadzu Corporation).

An equivalent of a functional group of the epoxy resin in the epoxy resin mixture is preferably 100 or more and 200 or less. In a case where the equivalent of the functional group is 100 or more, it is possible to obtain excellent ink resistance. In a case where the equivalent of the functional group is 200 or less, it is possible to obtain an excellent temporary fixing property. The equivalent of the functional group of the epoxy resin in the epoxy resin mixture is calculated by adding acetic acid and a tetraethylammonium bromide acetic acid solution to the epoxy resin mixture, and thereafter performing potentiometric titration with a 0.1 mol/L perchloric acid-acetic acid standard solution.

A content of the coumarone resin with respect to the epoxy resin is preferably 10 parts by mass or more and 50 parts by mass or less to 100 parts by mass of the epoxy resin, more preferably 20 parts by mass or more and 45 parts by mass or less to 100 parts by mass of the epoxy resin, still more preferably 21 parts by mass or more and 40 parts by mass or less to 100 parts by mass of the epoxy resin. The content is preferably 20 parts by mass or more and 40 parts by mass or less. In a case where the content is 10 parts by mass or more, it is possible to inhibit bleeding. In a case where the content is 50 parts by mass or less, it is possible to obtain the excellent temporary fixing property.

A hydroxyl value of the coumarone resin with respect to the epoxy resin mixture (mg KOH/g) is preferably 50 or less, especially preferably 40 or less. In a case where the hydroxyl value is 50 or less, it is possible to obtain the excellent ink resistance.

Examples of the powder curing agent include an amine-series curing agent, a phenol-series curing agent, and an acid anhydride-series curing agent. A softening point of the powder curing agent is preferably 80° C. or higher and 100° C. or lower.

In a case where the softening point is 80° C. or higher, it is possible to obtain the excellent ink resistance. In a case where the softening point is 100° C. or lower, it is possible to obtain the excellent temporary fixing property.

A content of the powder curing agent with respect to the epoxy resin is preferably 40 parts by mass or more and 65 parts by mass or less to 100 parts by mass of the epoxy resin. In a case where the content is 40 parts by mass or more, it is possible to inhibit the bleeding and obtain the excellent temporary fixing property. In a case where the content is 65 parts by mass or less, it is possible to obtain the excellent ink resistance.

The powder curing agent is preferably an amine-series curing agent, and an average particle diameter is preferably 70 nm or less. As the amine-series curing agent, primary amine, secondary amine, tertiary amine, or the like is used.

A diluent or another additive may be freely added to these resin compositions using a commonly used method. For example, a silane coupling agent can be added. As the silane coupling agent, a silane coupling agent having an epoxy group, a mercapto group, an isocyanate group, or a fluorene skeleton may be used.

In a method of manufacturing the adhesive agent according to the present disclosure, it is preferable that the coumarone resin be dissolved in the epoxy resin before the epoxy resin and the powder curing agent are mixed with each other. At this time, agitation may be performed while heat is applied.

### <Liquid Ejection Head>

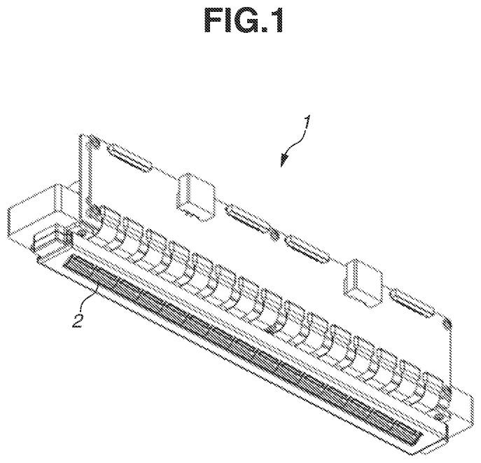

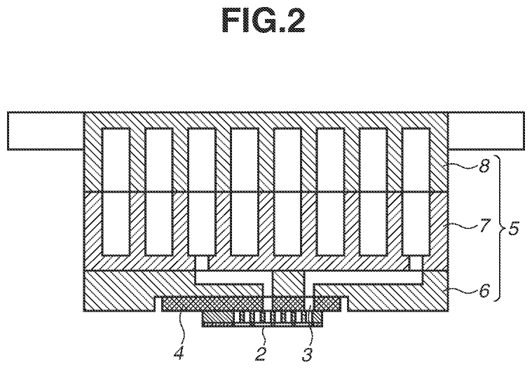

A configuration of the liquid ejection head according to the present disclosure is to be described with reference to the drawings. FIG. 1 is a schematic perspective view for describing one exemplary embodiment of the liquid ejection head according to the present disclosure. FIG. 2 is a schematic cross-sectional view of the liquid ejection head. A liquid ejection head 1 includes a recording element substrate 2, a supporting member 4, and a channel member 5. The recording element substrate 2 ejects a liquid such as ink. The supporting member 4 supports the recording element substrate 2 and includes a supply channel 3 that supplies a liquid to the recording element substrate 2. The channel member 5 supplies a liquid to the supply channel 3 for the liquid. At least one bonding surface between two members of any of the recording element substrate 2, the supporting member 4, and the channel member 5 is made of a cured substance of the above-mentioned adhesive agent.

The channel member 5 may be composed of a plurality of components. For example, the channel member 5 may be a channel member 5 composed of a first channel member 6, a second channel member 7, and a third channel member 8, as illustrated in FIG. 2.

For the supporting member 4 and the channel member 5, a resin exhibiting excellent dimension accuracy (engineering plastic) such as ceramics including alumina, a modified polyphenylene ether resin (“XYRON” (registered trademark) manufactured by Asahi Kasei Corporation) can be used.

### <Method of Manufacturing Liquid Ejection Head>

The method of manufacturing the liquid ejection head according to the present disclosure includes at least an application process, a bonding process, and a main curing process.

The application process is a process of applying the above-mentioned adhesive agent to at least one bonding surface between two members of any of the recording element substrate 2, the supporting member 4, and the channel member 5.

The bonding process is a process of crushing the adhesive agent applied onto the recording element substrate 2, the supporting member 4, and the channel member 5 with the two members of any of the recording element substrate 2, the supporting member 4, and the channel member 5.

In a case where the channel member 5 is the channel member 5 composed of the three members as illustrated in FIG. 2, the third channel member 8 and the second channel member 7 are preliminarily bonded to each other, and the first channel member 6 is further bonded to the second channel member 7, whereby the channel member 5 is manufactured.

In the bonding process, the adhesive agent is preferably crushed to have a thickness of 10 μm or less.

The main curing process is a process of curing the adhesive agent with heat. The method may include a temporary fixing/curing process before the main curing process. The temporary fixing/curing process is a process of applying heat to the adhesive agent to cure the adhesive agent in order to prevent a positional deviation of components during a manufacturing process. The temporary fixing curing process is characterized in that curing time is shorter than that in the main curing process, and may be performed simultaneously with the above-mentioned bonding process or performed after the bonding process.

The bleeding is a phenomenon that occurs in the main curing process, and in which the fluidity of the epoxy resin is increased by heat and the epoxy resin bleeds out, whereby an unreacted component of the epoxy resin remains after the curing. According to the present disclosure, dissolving the coumarone resin in the epoxy resin can increase the weight average molecular weight of the epoxy resin mixture and decrease fluidity under high temperature, and can thereby inhibit the bleeding-out of the epoxy resin in the main curing process.

The present disclosure will be described based on Examples and Comparative Examples. However, the present disclosure is not limited to the examples and comparative examples. A unit of an additive amount of each component described in Tables 1 to 4 means “parts by mass” unless otherwise specified.

Tables 1 to 3 indicate respective composition ratios of epoxy resin compositions used in Examples. Table 4 indicates respective composition ratios of epoxy resin compositions used in Comparative Examples.

Materials used in Tables 1 to 4 are as follows.

### (Bis A Type Epoxy Resin/Liquid at Normal Temperature)

Product name: jER825 manufactured by Mitsubishi Chemical Corporation
Product name: jER828 manufactured by Mitsubishi Chemical Corporation
Product name: jER806 manufactured by Mitsubishi Chemical Corporation

### (Polyfunctional Type Epoxy Resin/Liquid at Normal Temperature)

Product name: jER630 manufactured by Mitsubishi Chemical Corporation

### (Epoxy Resin/Solid at Normal Temperature)

Product name: jER 1001 manufactured by Mitsubishi Chemical Corporation

### (Coumarone Resin)

Product name: R100 (hydroxyl value: 10 mg, KOH/g) manufactured by Nitto Chemical Co., Ltd.
Product name: V120 (hydroxyl value: 30 mg, KOH/g) manufactured by Nitto Chemical Co., Ltd.
Product name: H100 (hydroxyl value: 50 mg, KOH/g) manufactured by Nitto Chemical Co., Ltd. (Amide-series powder curing agent)
Product name: EH-5030S manufactured by ADEKA Corporation
Product name: EH-5015S manufactured by ADEKA Corporation
Product name: EH-5046S manufactured by ADEKA Corporation
Product name: PN23J manufactured by Ajinomoto Fine-Techno Co., Inc.

### (Phenol-Series Powder Curing Agent)

Product name: jER 171N manufactured by Mitsubishi Chemical Corporation

### (Acid Anhydride-Series Powder Curing Agent)

Product name: TMTA-C manufactured by New Japan Chemical Co., Ltd.

### (Silane Coupling Agent)

Product name: A-187 manufactured by Momentive Performance Materials Japan LLC

A method of producing the epoxy resin compositions based on the composition ratios indicated in Tables 1 to 4 will be described, but the method is not limited to the above-mentioned method. A predetermined coumarone resin was added to each of the epoxy resins indicated in Tables 1 to 4, and a mixture was kneaded until the coumarone resin changed in form from a bead to powder. Agitation was performed at 1200 rpm under vacuum for five minutes using an agitator (product name: HIVIS MIX model 3 manufactured by PRIMIX Corporation) until the coumarone resin was completely dissolved in the epoxy resin. A powder curing agent indicated in each Table was added to the above-mentioned epoxy resin composition, and agitation was performed at 600 rpm under vacuum for five minutes using the above-mentioned agitator, whereby each epoxy resin composition was produced.

A bleeding property, a swelling rate, adhesiveness, and a temporary fixing property were evaluated with use of the produced epoxy resin compositions.

Regarding the bleeding property, the epoxy resin composition was applied to an adherend with a thickness of 100 μm, thereafter the epoxy resin composition was crushed with another adherend to have thicknesses of 10 μm, 20 μm, and 50 μm, and cured at 100° C. for one hour, thereafter the adherend was peeled off, and the presence/absence of an uncured component was visually observed, whereby the evaluation was performed based on the following criteria.
Very good: the uncured component is not observed even with the thickness of 10 μm.
Good: the uncured component is observed with the thickness of 10 μm, but not observed with the thickness of 20 μm.
Average: the uncured component is observed with the thickness of 20 μm, but not observed with the thickness of 50 μm.
Poor: the uncured component is observed even with the thickness of 50 μm.

Regarding the swelling rate, each epoxy resin composition was immersed in ink (ink for a service head manufactured by Canon Inc.) at a mass ratio of 1:20, an accelerated test was conducted at 121° C. for ten hours, the swelling rate was measured from a mass before and after the immersion of ink, whereby the evaluation was performed based on the following criteria.
Very good: the swelling rate is less than 10%.
Good: the swelling rate is 10% or more and less than 15%.
Average: the swelling rate is 15% or more and less than 20%.
Poor: the swelling rate is 20% or more.

Regarding the adhesiveness, the epoxy resin composition was applied to an adherend with a thickness of 100 μm, thereafter the epoxy resin composition was crushed with another adherend to have a thicknesses of 10 μm, and cured at 100° C. for one hour, the adherend was peeled off, and a peeling mode was observed, whereby the evaluation was performed based on the following criteria.
Very good: the adherend is damaged.
Good: cohesive failure occurs on the whole surface of the adhesive agent.
Average: each of cohesive failure of the adhesive agent and interfacial peeling between the adherend and the adhesive agent occurs in a mixed manner.
Poor: interfacial peeling occurs on the whole surface between the adherend and the adhesive agent.

Regarding the temporary fixing, gel time at 100° C. was measured with a sample with a thickness of 100 μm, and the evaluation was performed based on the following criteria.
Very good: the gel time is less than 8 seconds.
Good: the gel time is 8 seconds or more and less than 12 seconds.
Average: the gel time is 12 seconds or more and less than 15 seconds.

The weight average molecular weight of the epoxy resin mixture was calculated in terms of polystyrene by using gel permeation chromatography (for example, manufactured by Shimadzu Corporation). An equivalent of a functional group of the epoxy resin in the epoxy resin mixture was calculated by adding acetic acid and a tetraethylammonium bromide acetic acid solution to the epoxy resin mixture, and thereafter performing potentiometric titration with a 0.1 mol/L perchloric acid-acetic acid standard solution. Furthermore, a hydroxyl value of the coumarone resin can be calculated by acetylating a hydroxyl group in the coumarone resin using acetic anhydride with respect to a 1 g sample, and titrating remaining acetic acid with a potassium hydroxide solution. In a case of a commercialized product, data disclosed by a manufacturer (catalog value) can be used as the hydroxyl value of the coumarone resin.

TABLE 1
Examples 1 to 4 According to Present Disclosure

| | | | 1 | 2 | 3 | 4 |
|---|---|---|---|---|---|---|
| Epoxy resin | Epoxy resin | Bis A type | | | | 100 |
| mixture | | jER825 | | | | |
| | | Bis A type | | | 100 | |
| | | jER828 | | | | |
| | | Bis F type | 100 | 100 | | |
| | | jER806 | | | | |
| | | Polyfunctional | | | | |
| | | type jER630 | | | | |
| | Coumarone | R100 | 20 | 21 | | |
| | resin | V120 | | | 40 | 45 |
| | | H100 | | | | |
| Powder | Amine-series | EH-5030S | 40 | 40 | 40 | 40 |
| curing agent | curing agent | EH-5015S | | | | |
| | | PN23J | | | | |
| | | EH-5046S | | | | |
| | Phenol-series | jER171N | | | | |
| | curing agent | | | | | |
| | Acid anhydride- | TMTA-C | | | | |
| | series curing | | | | | |
| | agent | | | | | |
| Silane coupling agent | | A187 | 5 | 5 | 5 | 5 |
| Epoxy resin | Weight average molecular weight | | 600 | 600 | 300 | 300 |
| mixture | Equivalent of functional group of | | 210 | 200 | 100 | 90 |
| (epoxy resin + | epoxy resin | | | | | |
| coumarone | | | | | | |
| resin) | | | | | | |

| Bleeding property | | Good | Very | Very | Very |
|---|---|---|---|---|---|
| | | | good | good | good |
| Ink resistance | Swelling rate | Good | Very | Very | Good |
| | | | good | good | |
| | Adhesiveness | Good | Very | Very | Good |
| | | | good | good | |

| Temporary fixing property | Very | Very | Very | Good |
|---|---|---|---|---|
| | good | good | good | |

Table 1 indicates Examples 1 to 4 according to the present disclosure. In Examples 1 to 4, a type of the epoxy resin mixture was changed to change the weight average molecular weight of the epoxy resin mixture. In a case where the weight-average molecular weight was between 300 and 600, the compatibility among the bleeding property, the ink resistance, and the temporary fixing property was established. Furthermore, in Examples 1 to 4, a type of the coumarone resin and an additive amount were changed to change the equivalent of the functional group of the epoxy resin in the epoxy resin mixture. In comparison between Examples 1 and 2, in a case where the equivalent exceeded 200, the ink resistance degraded. This is thought to be because the additive amount of the coumarone resin that does not swell in ink was below an additive amount necessary for maintaining the ink resistance, whereby the ink resistance of the epoxy resin composition degraded. Similarly, in a case where the equivalent exceeded 200, the bleeding property also degraded. This is thought to be because the coumarone resin having lower fluidity decreased, whereby the fluidity of the epoxy resin mixture increased. Meanwhile, in comparison between Examples 3 and 4, in a case where the additive amount of the coumarone resin exceeded 45 parts by mass, the ink resistance and the temporary fixing property degraded.

This is thought to be because the coumarone resin in excessive amount hindered the reaction between the epoxy resin and the curing agent, whereby a reaction rate decreased.

TABLE 2
Example 5 According to Present Disclosure

| | | | 5 |
|---|---|---|---|
| Epoxy resin | Epoxy resin | Bis A type jER825 | |
| mixture | | Bis A type jER828 | 100 |
| | | Bis F type jER806 | |
| | | Polyfunctional | |
| | | type jER630 | |
| | Coumarone resin | R100 | |
| | | V120 | |
| | | H100 | 21 |
| Powder curing | Amine-series curing | EH-5030S | 40 |
| agent | agent | EH-5015S | |
| | | PN23J | |
| | | EH-5046S | |
| | Phenol-series curing | jER 171N | |
| | agent | | |
| | Acid anhydride-series | TMTA-C | |
| | curing agent | | |

| | | |
|---|---|---|
| Silane coupling agent | A187 | 5 |

| | | |
|---|---|---|
| Epoxy resin mixture | Weight average molecular weight | 600 |
| (epoxy resin + | Hydroxyl value of coumarone resin | 50 |
| coumarone resin) | | |

| Bleeding property | | Very |
|---|---|---|
| | | good |
| Ink resistance | Swelling rate | good |
| | Adhesiveness | Very |
| | | good |

| | |
|---|---|
| Temporary fixing property | Very |
| | good |

Table 2 indicates Example 5 according to the present disclosure. In Example 5, a coumarone resin having a high hydroxyl value (mg KOH/g) was used. Because an ink component is adsorbed to the hydroxyl group in the coumarone resin as the hydroxyl value of the coumarone resin becomes higher, the swelling rate is thought to decrease. However, in a case where the hydroxyl value is 50 or less, the compatibility among the bleeding property, the ink resistance, and the temporary fixing property is established.

TABLE 3
Examples 6 to 11 According to Present Disclosure

| | | | 6 | 7 | 8 | 9 | 10 | 11 |
|---|---|---|---|---|---|---|---|---|
| Epoxy resin | Epoxy | Bis A | | | | | | |
| mixture | resin | type | | | | | | |
| | | jER825 | | | | | | |
| | | Bis A | 100 | 100 | 100 | 100 | 100 | 100 |
| | | type | | | | | | |
| | | jER828 | | | | | | |
| | | Bis F | | | | | | |
| | | type | | | | | | |
| | | jER806 | | | | | | |
| | | Polyfunctional | | | | | | |
| | | type | | | | | | |
| | | jER630 | | | | | | |
| | Coumarone | R100 | 21 | 21 | 21 | 21 | 21 | 21 |
| | resin | V120 | | | | | | |
| | | H100 | | | | | | |
| Powder | Amine- | EH- | 39 | | | | | |
| curing agent | series | 5030S | | | | | | |
| | curing | EH- | | 40 | | | | |
| | agent | 5015S | | | | | | |
| | | PN23J | | | 65 | | | |
| | | EH- | | | | 66 | | |
| | | 5046S | | | | | | |
| | Phenol- | jER171N | | | | | 40 | |
| | series | | | | | | | |
| | curing | | | | | | | |
| | agent | | | | | | | |
| | Acid | TMTA-C | | | | | | 40 |
| | anhydride- | | | | | | | |
| | series | | | | | | | |
| | curing | | | | | | | |
| | agent | | | | | | | |

| | | | | | | |
|---|---|---|---|---|---|---|
| Silane coupling agent | A187 | 5 | 5 | 5 | 5 | 5 |

| | | | | | | | |
|---|---|---|---|---|---|---|---|
| Epoxy resin | Weight average | 600 | 600 | 600 | 600 | 600 | 600 |
| mixture | molecular weight | | | | | | |
| Powder | Softening point ° C. | 70 | 85 | 100 | 120 | 80 | 85 |
| curing agent | Average particle | 70 | 70 | 70 | 70 | 100 | 120 |
| | diameter nm | | | | | | |

| Bleeding property | | Good | Very | Very | Good | Avg. | Avg. |
|---|---|---|---|---|---|---|---|
| | | | good | good | | | |
| Ink resistance | Swelling | Good | Very | Very | Good | Avg. | Avg. |
| | rate | | good | good | | | |
| | Adhesiveness | Good | Very | Very | Good | Avg. | Avg. |
| | | | good | good | | | |

| | | | | | | |
|---|---|---|---|---|---|---|
| Temporary fixing property | Good | Very | Very | Avg. | Very | Very |

| | | | |
|---|---|---|---|
| good | good | good | good |

Table 3 indicates Examples 6 to 11 according to the present disclosure. In Examples 6 to 9, the additive amount of the powder curing agent was changed and the type of the powder curing agent was also changed, whereby the softening point of the curing agent was increased or decreased.

Particularly, in Examples 7 and 8, the additive amount of the curing agent is 40 parts by mass or more and 65 parts by mass or less and the softening point of the curing agent is 80° C. or higher and 100° C. or lower, whereby the compatibility among the bleeding property, the ink resistance, and the temporary fixing property is established.

In a case where the additive amount of the curing agent is 40 parts by mass or more and 65 parts by mass or less, the epoxy resin and the curing agent can react with each other without excess and deficiency nor a decrease in the curing reaction rate, whereby the bleeding-out due to an unreacted epoxy resin or an unreacted curing agent is inhibited, and a sufficient temporary fixing property can be obtained. Even if a cured substance is immersed in ink after the curing, the elution of the unreacted curing agent in ink is inhibited.

In a case where the softening point of the curing agent is 80° C. or higher and 100° C. or lower, a time period until the curing agent is softened and liquefied or a time period until the curing reaction is started and the curing agent is turned into a gel are shortened, and a sufficient reaction rate can be implemented. Hence, the bleeding-out due to the unreacted epoxy resin and the unreacted curing agent is inhibited, and a sufficient temporary fixing property can be obtained.

Because a sufficient crosslink density can be obtained, even if the cured substance is immersed in ink after the curing, the absorption of ink is inhibited.

In comparison between Examples 8 and 9, all the bleeding property, the ink resistance, and the temporary fixing property degraded in Example 9 compared with Example 8.

The degradation in the bleeding property is thought to be because of the following reasons.

Because the additive amount of the curing agent is more than 65 parts by mass, the unreacted curing agent remains after the curing. Furthermore, because the softening point of the curing agent is higher than 100° C., it takes longer for the curing agent to be softened and liquefied. Because of these points, the epoxy resin becomes easier to bleed out.

The degradation in the ink resistance is thought to occur for the reasons as below. In a case where the additive amount of the curing agent is more than 65 parts by mass, the unreacted curing agent remains after the curing, and the remaining curing agent is eluted in ink when the curing agent is immersed in ink. Furthermore, in a case where the softening point of the curing agent is higher than 100° C., a time period from the start of the curing reaction until the gelation of the curing agent becomes longer.

In Example 10, a phenol-series curing agent was used instead of the amine-series curing agent to further increase the average particle diameter of the curing agent. As a result, the bleeding property and the ink resistance degraded.

The degradation in the bleeding property is thought to occur because the average particle diameter of the curing agent was large, whereby it took longer for the curing agent to be turned into a gel and fully liquefied. The degradation in the ink resistance is thought to occur because the phenol-series curing agent used in Example 10 is more susceptible to the swelling of ink than the amine-series curing agent used in Examples 6 to 9. Furthermore, it is thought that the adhesiveness further degraded because the silane coupling agent was not added in Example 10.

In Example 11, an acid anhydride-series curing agent was used. As a result, the bleeding property and the ink resistance degraded similarly to the case where the phenol-series curing agent was used in Example 10.

The degradation in the bleeding property is thought to occur because the reaction of the acid anhydride-series curing agent is slower than the reaction of the amine-series curing agent and the average particle diameter of the acid anhydride-series curing agent is larger than that of the amine-series curing agent. The degradation in the ink resistance is also thought to be because the acid anhydride-series curing agent is more susceptible to the swelling of ink than the amine-series curing agent similarly to the phenol-series curing agent.

TABLE 4
Comparative Example in Present Disclosure

| | | | 1 | 2 | 3 |
|---|---|---|---|---|---|
| Epoxy resin | Epoxy resin | Bis A type | 100 | | 100 |
| mixture | (liquid | jER825 | | | |
| | at normal | Bis A type | | | |
| | temperature) | jER828 | | | |
| | | Bis F type | | | |
| | | jER806 | | | |
| | | Polyfunctional | | 100 | |
| | | type jER630 | | | |
| | Epoxy resin | jER1001 | | | 21 |
| | (solid | | | | |
| | at normal | | | | |
| | temperature) | | | | |
| | Coumarone resin | R100 | 21 | 21 | |
| | | V120 | | | |
| | | H100 | | | |
| Powder curing | Amine-series | EH-5030S | 40 | 40 | 40 |
| agent | curing agent | EH-5015S | | | |
| | | PN23J | | | |
| | | EH-5046S | | | |
| | Phenol-series | jER 171N | | | |
| | curing agent | | | | |
| | Acid anhydride- | TMTA-C | | | |
| | series curing | | | | |
| | agent | | | | |

| | | | | |
|---|---|---|---|---|
| Silane coupling agent | A187 | 5 | 5 | 5 |

| | | | | |
|---|---|---|---|---|
| Epoxy resin | Weight average molecular | 290 | 700 | 300 |
| mixture | weight | | | |

| Bleeding property | | Poor | Very | Very |
|---|---|---|---|---|
| | | | good | good |
| Ink resistance | Swelling rate | Very | Poor | Poor |
| | | good | | |
| | Adhesiveness | Very | Poor | Poor |
| | | good | | |

| | | | |
|---|---|---|---|
| Temporary fixing property | — | — | — |

Table 4 indicates Comparative Examples 1 to 3. In Comparative Example 1, the weight average molecular weight of the epoxy resin mixture was less than 300, and the bleeding property was insufficient. This is thought to be because the epoxy resin bled out due to the higher fluidity of the epoxy resin mixture at the time of the curing. Meanwhile, in Comparative Example 2, the weight average molecular weight of the epoxy resin mixture was large, and the ink resistance was insufficient. This is thought to be because the rate of reaction with the curing agent decreased due to the lower fluidity of the epoxy resin. In Comparative Example 3, an epoxy resin that was solid at normal temperature was dissolved instead of the coumarone resin, but the ink resistance was insufficient. This is thought to be because the coumarone resin does not absorb ink, while the epoxy resin absorbs ink in between molecules.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-065827, filed Apr. 13, 2023, which is hereby incorporated by reference herein in its entirety.

What is claimed is:

1. A liquid ejection head comprising:
a recording element substrate configured to eject a liquid;
a supporting member configured to support the recording element substrate and including a supply channel configured to supply a liquid to the recording element substrate; and
a channel member configured to supply a liquid to the supply channel,
wherein at least one bonding surface between two members of any of the recording element substrate, the supporting member, and the channel member is made of an epoxy resin composition containing an epoxy resin mixture and a powder curing agent,
wherein the epoxy resin mixture contains an epoxy resin that is liquid at normal temperature and a coumarone resin that is dissolvable in the epoxy resin,
wherein a weight average molecular weight of the epoxy resin mixture is 300 or more and 600 or less, and
wherein the liquid ejection head contains a cured substance of an adhesive agent containing the epoxy resin composition.

2. The liquid ejection head according to claim 1, wherein an equivalent of a functional group of the epoxy resin in the epoxy resin mixture is 100 or more and 200 or less.

3. The liquid ejection head according to claim 2, wherein a content of the coumarone resin contained in the epoxy resin mixture is 10 parts by mass or more and 50 parts by mass or less to 100 parts by mass of the epoxy resin.

4. The liquid ejection head according to claim 3, wherein a hydroxyl value (mg KOH/g) of the coumarone resin is 50 or less.

5. The liquid ejection head according to claim 1, wherein a softening point of a powder curing agent contained in the epoxy resin composition is 80° C. or higher and 100° C. or lower.

6. The liquid ejection head according to claim 5, wherein a content of the powder curing agent contained in the epoxy resin composition is 40 parts by mass or more and 65 parts by mass or less to 100 parts by mass of the epoxy resin.

7. The liquid ejection head according to claim 6, wherein the powder curing agent is an amine-series curing agent.

8. The liquid ejection head according to claim 7, wherein an average particle diameter of the powder curing agent is 70 nm or less.

9. The liquid ejection head according to claim 1, wherein the epoxy resin composition contains a silane coupling agent.

10. A method of manufacturing a liquid ejection head, the liquid ejection head including:
a recording element substrate configured to eject a liquid;
a supporting member configured to support the recording element substrate and including a supply channel configured to supply a liquid to the recording element substrate; and
a channel member configured to supply a liquid to the supply channel,
the liquid ejection head using an adhesive agent containing an epoxy resin composition,
the method comprising:
applying the adhesive agent to at least one bonding surface between two members of any of the recording element substrate, the supporting member, and the channel member;
bonding the two members to each other; and
performing main curing to cure the adhesive agent with heat and bond the two members to each other,
wherein the adhesive agent is the epoxy resin composition containing an epoxy resin mixture and a powder curing agent,
wherein the epoxy resin mixture contains an epoxy resin that is liquid at normal temperature and a coumarone resin that is dissolvable in the epoxy resin, and
wherein a weight average molecular weight of the epoxy resin mixture is 300 or more and 600 or less, and
wherein the liquid ejection head contains a cured substance of an adhesive agent containing the epoxy resin composition.

11. The method of manufacturing the liquid ejection head according to claim 10, wherein, in the bonding, a thickness of the epoxy resin composition after the bonding is 10 μm or less.

12. The method of manufacturing the liquid ejection head according to claim 10, further comprising performing temporary fixing/curing to temporarily fix the two members with the adhesive agent before the main curing.

13. The method of manufacturing the liquid ejection head according to claim 10, wherein an equivalent of a functional group of the epoxy resin in the epoxy resin mixture is 100 or more and 200 or less.

14. The method of manufacturing the liquid ejection head according to claim 13, wherein a content of the coumarone resin contained in the epoxy resin mixture is 10 parts by mass or more and 50 parts by mass or less to 100 parts by mass of the epoxy resin.

15. The method of manufacturing the liquid ejection head according to claim 14, wherein a hydroxyl value (mg KOH/g) of the coumarone resin is 50 or less.

16. The method of manufacturing the liquid ejection head according to claim 10, wherein a softening point of a powder curing agent contained in the epoxy resin composition is 80° C. or higher and 100° C. or lower.

17. The method of manufacturing the liquid ejection head according to claim 16, wherein a content of the powder curing agent contained in the epoxy resin composition is 40 parts by mass or more and 65 parts by mass or less to 100 parts by mass of the epoxy resin.

18. The method of manufacturing the liquid ejection head according to claim 17, wherein the powder curing agent is an amine-series curing agent.

19. The method of manufacturing the liquid ejection head according to claim 18, wherein an average particle diameter of the powder curing agent is 70 nm or less.

20. The method of manufacturing the liquid ejection head according to claim 10, wherein the epoxy resin composition contains a silane coupling agent.
